(19) United States
(12) Patent Application Publication
(10) Pub. No.: US 2009/0073878 A1
(43) Pub. Date: Mar. 19, 2009

(54) Usage based queuing with accounting for wireless access points

(76) Inventor: Kenneth Gustav Carlberg, Baltimore, MD (US)

Correspondence Address: KENNETH CARLBERG, 4450 ROLAND SPRINGS DR, BALTIMORE, MD, 21210, US

(21) Appl. No.: 12/230,500

(22) Filed: Aug. 29, 2008

Related U.S. Application Data
(60) Provisional application No. 60/935,794, filed on Aug. 31, 2007.

(51) Int. Cl. H04L 12/24

(52) U.S. Cl. 370/230

(57) ABSTRACT

One embodiment of a queuing mechanism using an Accounting component 220 that applies previous state of a flow, along with usage policies, to determine if a packet is dropped or enqueued for transmission to an output interface. The decision process is done independent of the congestive state of the output interface. In addition, the rate of degradation or augmentation of a flow is divided into three phases: (1) an initial state upon which drop probability is increased or decreased, (2) a variable rate of degradation or augmentation, and (3) a maximum rate or threshold of augmentation or degradation. Finally, the design is based on soft state retention of information so that timeouts of activity allow the system to automatically clear state and start from a NULL or zero history.

### CROSS-REFERENCE TO RELATED APPLICATIONS

This application claims the benefit of provisional patent application No. 60/935, 794, country code of US, filed Aug. 31, 2007 by the present inventor.

### FEDERALLY SPONSORED RESEARCH

None

### SEQUENCE LISTING

None

### BACKGROUND OF THE INVENTION

### Field of the Invention

This invention relates to the queue management and service model in use within a Wireless Access Point.

### DEFINITION OF TERMS

Node: A node is a device that receives and/or transmits packets. It contains one or more Network Interface Cards (NIC) that connects the node to other nodes in a network. NICs can be comprised of connections (e.g., fiber) or wireless connections.

Packet: A collection of bits that at a minimum has a Header and a Body. Some packets may also include a Tail. Headers and Tails contain control information (in the form of one or more fields), and the Body contains the payload. The Payload may also be in the form of an embedded packet.

Tuple: A collection of fields within a Header or Tail that identifies one or more packets.

Flow: A collection of one or more packets that conform to the same tuple.

State: Information acquired and stored from the Header (and/or Tail) of a packet. State may also be obtained from out-of-band signaling.

### PRIOR ART

Many communication networks rely on queues to temporarily store units of information, which we term packets, for transmission in cases where the egress interface of a node cannot transmit packets at the same rate it has received them. The simplest and most common type of queuing system is known as First In First Out (FIFO), and is typically implemented as a single queue per output interface.

Internet Protocol (IP) packets can be variable size in length. The difference in packet size correlates to proportional assignment of resources (e.g., buffer space) within a node. Thus, larger packets require more resources than smaller ones. From the perspective of servicing queues on a per packet basis, this raises an issue of fairness in the context of resource allocation given that resources within a node are finite. Prior art describes complex queuing systems comprised of classification, shaping, and policing components that together with instantaneous queue size help achieve fairness in servicing packets. Examples include Class-Based Queuing (CBQ), Weighted Fair Queuing (WFQ), and Priority Queuing (PQ).

Classification involves selection of ingress packets based on discriminators in the form of a predefined tuple. After classification is performed, additional processing is done to determine the destination egress interface and if based on instantaneous queue size the packet can be placed into a queue for eventual transmission. A given egress interface may have several queues associated with it, with fairness criteria used to determine how and when packets are to be serviced for transmission or discarded.

The application of policing/shaping in servicing packets through queue management determines the Quality of Service (QoS) experienced by that packet. QoS is measured in terms of delay and packet loss and corresponds to a service model associated with flows (i.e., series of packets that share the same tuple information). Prior art has defined several service models for IP networks. Two examples of these service models are known as Controlled-Load Service and Guaranteed Service. Both of these service models rely on admission control, packet schedulers, and packet classifiers to provide a specific type of QoS. The default service model in the Internet is known as Best Effort.

During periods of congestion at output queues, flows that have passed admission control conform to a specific service model (e.g., a rate of transmission to the next node along a path). Other flows designated for the same congested output queue, and designated as Best Effort, experience a form of degraded service where some percentage (possibly 100%) of the packets are discarded because the queue is full. The decision to drop packets has been the subject of various patents: U.S. Pat. No. 7,006,440 B2; U.S. Pat. No. 5,381,413; U.S. Pat. No. 6,345,038 B1; U.S. Pat. No. 6,981,052 B1; U.S. Pat. No. 6,104,700. In each of these cases, the decision to degrade the service of a flow (i.e., drop packets), is based on instantaneous condition or congestive state of an output queue. None of these approaches rely on accounting of previous usage of resources by the same flow.

A Wireless Access Point (WAP) is a node used to connect wireless device(s) to and from a network. Typically, a WAP is connected to a wired network, thereby extending the connectivity of the wireless nodes to non-wired nodes. When used to connect nodes that exchange IP packets, WAPs typically use simple FIFO queues and support the Best Effort Service model. In less frequent cases, WAPs support a form of fair queuing as described in prior art and in turn provides various levels of QoS.

Regardless of the queuing system in place, instantaneous queue size and its congestive state have always been taken into consideration in supporting fairness. In addition, historical state information of previously serviced packets of the flow have not been taken into account when servicing the current packet. This means that while fairness is applied to the current state of the queuing system, previous history, which may reflect heavy usage by a particular flow/tuple, is never factored in to the current instantaneous notion of fairness.

What is needed is a means of supporting usage policies that take into account previous state and place limits on the measure in which flows use the resources of a node. In addition, these limits need to be dynamic so that they are not a binary decision of continued usage. In a broader perspective, unfairness that can be defined and managed needs to be reintroduced into networking systems, and WAPs in particular.

### SUMMARY

The invention is a queuing system whose primary embodiment features an accounting mechanism used to support a change in QoS of a flow regardless of traffic shaping responsibilities or the current congestive state of the queue. The rate of change in QoS of a flow, as well as the criteria by which it is activated and remains active, is subject to usage configuration constraints set within the node. For the sake of simplicity, these usage configuration constraints are referred to as usage policies.

The addition of accounting allows the queuing system to accumulate state from previous packets of a flow and thus consider factors other than the instantaneous queue size, resource utilization, or QoS bounds of a node. This accumulated state may be based on packet counts, temporal information (e.g., number of packets received within a specific time frame) derived from a specific class (i.e., tuple), or some combination thereof. The critical aspect is that state from the previous history of packets sharing the same tuple influences the current QoS applied to a currently serviced packet.

Usage policies are tangential to the reception, classification, and congestive state of a queuing system within a node. The embodiment of usage policies defines the commencement of the constraint, the dynamic rate to which it is applied to the QoS of each packet of a flow, the maximum bound of increase or decrease of QoS, and the criteria for terminating its application to a flow. This criteria allows the mechanism to operate in a soft-state manner, meaning that the state or condition applied to a particular flow terminates if identified conditions (e.g., continued reception of packets of the flow, or temporal limits) ceases.

A distinctive feature of this invention is that the dynamic rate QoS defined by the usage policies can be unique per flow. This means that different flows, which may be multiplexed, may exhibit different QoS at different rates independent of any shaping/policing and/or current state of the output queue. Thus, the change in QoS may be gradual and slight, or it may be sudden and considerable (e.g., exponential) per packet of a flow. The difference in QoS is defined by the usage policy and the historical accounting information of the flow.

One embodiment of the invention, with its use of accounting and usage constraint information, is in the form of a simple queuing system (e.g., a single FIFO queue per output interface). Another embodiment of the invention involves more complex queuing systems that include accounting and usage policies with shaping/policing as described in prior art. The unique feature of this latter example is that this invention can introduce a measure of unfairness in the processing of packets by a fair queuing system.

One embodiment of unfairness is a gradual degradation of service (e.g., dropping a subset of packets of a flow) even if all output queues are empty or at least capable of containing an additional packet. Another embodiment of unfairness is added delay in the servicing of the packet for transmission through the egress interface beyond that dictated by shaping. The converse is also achievable in that certain packets can get preferential treatment (e.g., non-dropping of packets or lower delay) even if the policing/shaping indicate otherwise.

Placing the embodiments of this invention within a Wireless Access Point introduces the means of achieving unfairness (and different service models like Degraded Service) into the first hop or link from the wireless device (i.e., end node) to the rest of the network. Hence, accounting and the application of previous state together with usage policies can be applied to flows emanating from or destined to other wireless devices served by the Wireless Access Point, or to other devices that are upstream or downstream of the Wireless Access Point.

A local database of information is used to store configuration and current state information for use by the invention. Configuration information includes usage policies that define degraded or preferential service beyond that defined by the shaper/policer or the current non-congested queue size. Configuration information also includes specific tuples that are exempt from unfairness or preferential treatment.

### DRAWINGS

### Reference Numerals

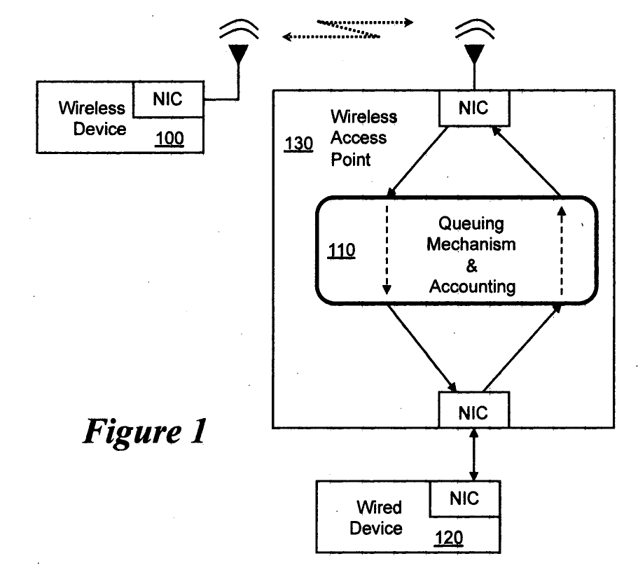

FIG. 1 is an exemplary embodiment of an enterprise network featuring a Wireless Access Point acting as a conduit for packets sent between wired and wireless device(s).

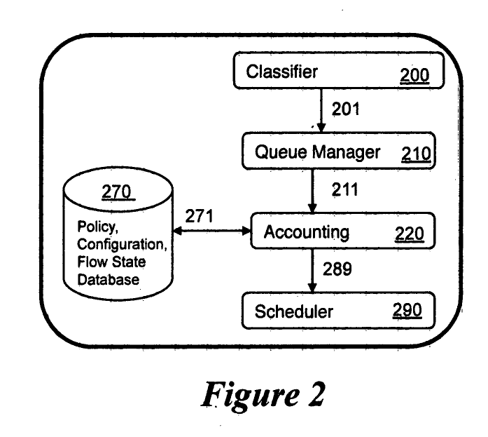

FIG. 2 provides a more detailed embodiment of the invention in terms of the Queuing Mechanism & Accounting component shown in FIG. 1.

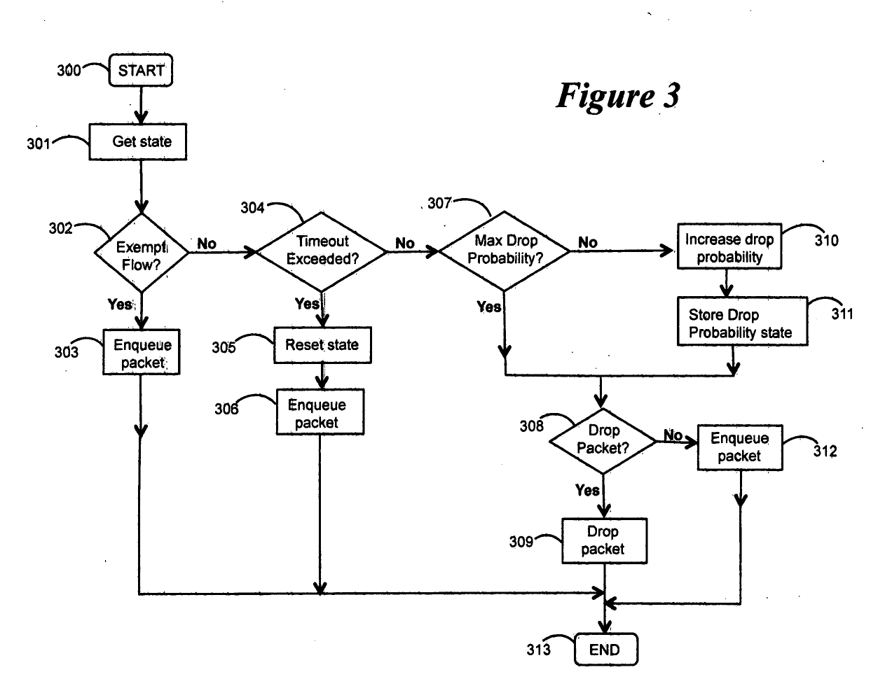

FIG. 3 provides a more detailed embodiment, in the form of a flow chart, of the Accounting 220 component of FIG. 2 used to store current and previous information about flows transiting the node.

### DETAILED DESCRIPTION OF THE EMBODIMENTS

The invention is a queuing mechanism that incorporates an accounting feature that retains state of existing and previous flows transiting node used to allocate resources (e.g., buffer space, queue size) regardless of the congestive state of a node. This allows the node to allocate more or less resources, based on configured policies, to a flow based on previous history of past flows that have transited the node. FIGS. 2 and 3 represents a progressively more detailed embodiment of the invention.

FIG. 1 is an exemplary embodiment of an enterprise network featuring a Wireless Access Point 130 acting as a conduit for packets sent between wired 120 and wireless 100 device(s). A Network Interface Card (NIC) resides in each device and is the ingress and egress points for packets sent through the network. Within the Wireless Access Point, the embodiments of the invention are contained in the Queuing Mechanism & Accounting 110 component.

FIG. 2 provides a more detailed embodiment of the invention in terms of the Queuing Mechanism & Accounting 110 component shown in FIG. 1. The Classifier 200, Queue Manager 210, and Scheduler 230 are components that are common in prior art. The Accounting component 220 represents the embodiment of the invention that is not found in prior art in that the Accounting component 220 retains state, both current and previous information, of flows that have transited the node. This allows the node to apply policies and allocate resources based on a history of past information instead of current instantaneous state of the node.

The complexity of the queuing system is increased when the Queue Manager 210 supports a policer/shaper function. The Policy & Configuration Database 270 stores pre-configured information, past state, and current state information of the flows traversing the Wireless Access Point. This policy and state information is exchanged with the Accounting component 220 as denoted in the bi-directional notation of 271.

If a policy articulates a limit in resources for a specific tuple correlating to a flow of packets, then packets may be discarded even though the current instantaneous condition of available resources (e.g., output queue) is under utilized.

The servicing of packets through various components of the queuing system is denoted in FIG. 2 as directional arrows 201, 211, and 221. Configuration information coupled with policy and current state of flows transiting the node are provided to the Accounting 110 component, as denoted by directional arrow 241. Although not shown, additional policy information may be supplied to the other components of the queuing system of FIG. 2.

FIG. 3 provides a more detailed embodiment, in the form of a flow chart, of the Accounting 220 component of FIG. 2. The START 300 notation in FIG. 3 represents the beginning of the packet flow and through the decision process of the Accounting component 220 of FIG. 2. The END 313 notation in FIG. 3 represents the termination of the decision process, at which point a packet has either been discarded or placed in an output queue for transmission.

The first action taken in the Accounting 220 component of FIG. 2 is obtaining state 301 (in FIG. 3) of the flow that matches the tuple from the packet waiting to be placed in the output queue. If the flow is exempt from usage policy 302, and therefore exempt from any constraints or augmentations of resources, then the packet is placed in the output queue 303 and further processing of the packet in the Accounting 220 component of the invention is terminated 313.

If the flow is not exempt from usage policy, then the node determines if the state associated with a flow has timed out 304. The invention uses a soft state design to store and retain information. If packets of a flow have not traversed the node within some preconfigured time scale, then previous state is reset to Null or zero 305 and new state is started using the current packet as the initial element to build and retain state. The current packet is placed in the output queue 306 and further processing of the packet in the Accounting 220 component of the invention is terminated 313.

If the timeout of state 304 has not exceeded a preconfigured limit, then the node determines if the maximum drop probability 307 has been reached. The maximum drop probability is a preconfigured threshold placing a limit on the highest probability that a packet is dropped regardless of the current congestive state of the output queue. If this preconfigured threshold has been reached, then the node determines if the packet should be discarded 308. This determination is a result from a random number generator value compared against the current drop probability value. If the random value exceeds the current drop probability value, then the packet is placed in the output queue 312. Otherwise, the packet is discarded 309 and further processing of the packet in the Accounting 220 component of the invention is terminated 313.

If the packet and its previous state information has not exceeded the maximum drop probability threshold 307, then the associated drop probability is increased 310 and the updated information is stored in the flow state database 270 component of FIG. 2. Depending on the configured usage policy, the decision of increasing the drop probability can be inverted to decreasing the drop probability, thereby augmenting previously allocated resources for the flow. Given the updated state information, the Accounting component 220 determines if the packet should be dropped 308. If yes, then the packet is discarded. Otherwise, the packet is placed in the queue and further processing of the packet in the Accounting 220 component of the invention is terminated 313.

### ADVANTAGES

From the description above, a number of advantages of the embodiment become evident.
(a) Usage policies can be defined for the node utilizing the invention that place additional constraints on the allocation of resources (e.g., entries in an output queue) for a flow.
(b) The combination of usage policies with previous state obtained by flows transiting a node allows the queuing system to make decisions in the allocation of resources based on past history (i.e., state) as opposed to instantaneous conditions of the node.
(c) Security policies can be added to the Database component 270 and combined with usage policies and accounting information to provide protection from Denial of Service attacks.
(d) Usage policies can be defined to decrease or increase the amount of available resources set aside for the packets of a flow.
(e) The ability to define both an increase of probability and a maximum drop probability allows administrators of the node (and its pre-configured data) to define a resource allocation scheme in three phases: (1) a start threshold in terms of when usage policies take affect, (2) a variable rate of degradation or augmentation of resources, and (3) a maximum level of allocation or constraint of resources.
(f) The soft state design allows the system to automatically reset old or stale information to a NULL or initial condition.

1) A method for allocating resources within a node for a received packet to be transmitted from an output queue based on:
current conditions that do not reflect congestion collapse;
previously stored state (accounting) for the flow from previously received packets corresponding to the same tuple;
a set of pre-configured usage policies defined for a tuple that define usage constraints further limiting or augmenting the resources made available to a packet for transmission;
a set of usage constraints that can change over time;
a set of constraints that can change over load.

2) The method of claim 1, wherein packets may be dropped regardless of the congestive state of the output interface.

3) The method of claim 1, wherein security policies are defined and combined with usage policies to constrain resource allocation in defense from Denial of Service attacks.

4) The method of claim 3, wherein security policies are defined and combined with usage policies to constrain resource allocation in defense from replay attacks.
